(19) United States
(12) Patent Application Publication
(10) Pub. No.: US 2026/0300623 A1
(43) Pub. Date: Oct. 1, 2026

(54) COPY SUPPRESSION FOR RETRIEVAL-AUGMENTED GENERATION OUTPUTS

(71) Applicant: Amazon Technologies, Inc., Seattle, WA (US)

(72) Inventors: Aws Albarghouthi, Middleton, WI (US); Tancrede Lepoint, New York, NY (US)

(21) Appl. No.: 19/092,781

(22) Filed: Mar. 27, 2025

(51) Int. Cl. G06F 40/284; G06F 16/31

(52) U.S. Cl. CPC G06F 40/284; G06F 16/313

(57) ABSTRACT

Described are systems and processes for providing copy protection in results provided by a Large Language Model (LLM) that uses Retrieval-Augmented Generation (RAG) of data sources. The data sources may be sharded into a first shard and a second shard. A first query may be sent to the LLM using RAG with the first shard to determine a token with a first probability. A second query may be sent to the LLM using RAG with the second shard to determine the token with a second probability. A combined probability may be determined for the token based on the first probability and the second probability. The combined probability may be used to select the token. These systems and processes reduce a risk that the LLM is too closely tied to any specific data and thus replicates an extended amount of that data.

### BACKGROUND

A Large Language Model (LLM) is capable of generating responses to many different queries based on training data used to train the LLM. However, the training data used to train the LLM may not be exhaustive. For example, the training data may not include recently created data, proprietary data, or other types of data that may not have been available during training for various reasons. To overcome this limitation, retrieval-augmented generation (RAG) may be implemented to provide other reference data to an LLM that may be relevant to help the LLM generate a meaningful response to a query. For example, a service may use the LLM to provide answers to questions about proprietary data maintained by the service and may provide the proprietary data using RAG.

While implementation of RAG with an LLM can be helpful to overcome data knowledge limitations of conventional LLM systems, there are some drawbacks. For example, when an LLM is provided with a source document that includes information to facilitate generating a response to a query, the LLM may overly rely on that source document and copy extended portions of the source document when generating the response. This may result in revealing confidential information from the source document, create a copyright violation, or may result in other unintended consequences. One conventional guardrail against revealing confidential information includes inspecting information generated by an LLM in a response to a request to determine if the response includes confidential or copyrighted information in violation of a policy and then preventing the response from being output when a violation is detected. However, this approach provides a poor user experience by preventing a response to the request.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a schematic diagram of an illustrative environment to prevent output of sensitive data in generative text provided by a large language model (LLM) implemented with retrieval-augmented generation (RAG), according to an implementation.

FIG. 2 is a schematic diagram showing sharding of data sources, according to an implementation.

FIG. 3 is a schematic diagram showing combining probabilities of tokens based on queries using different shards, according to an implementation.

FIG. 4 is a schematic diagram showing probabilities generated using a smoothing function, according to an implementation.

FIG. 5 is a flow diagram of an example process to prevent output of sensitive data in generative text provided by an LLM implemented with RAG, in accordance with disclosed implementations.

FIG. 6 is a flow diagram of an example process to shard a data source into two or more shards, according to an implementation.

FIG. 7 is a flow diagram of an example process to combine probabilities of a token resulting from queries of different shards, according to an implementation.

FIG. 8 is a flow diagram of an example process to combine probabilities of a token resulting from queries of different shards and a query of the data source, according to an implementation.

FIG. 9 is a flow diagram of an example process to implement a threshold to limit generation of consecutive tokens from a same shard, according to an implementation.

FIG. 10 is a flow diagram of another example process to prevent output of sensitive data in generative text provided by an LLM implemented with RAG, in accordance with disclosed implementations.

FIG. 11 is a system services diagram that shows aspects of several services that can be provided by and utilized within a service provider network, according to an implementation.

FIG. 12 shows an example computer architecture for a computer capable of executing program components, according to an implementation.

While implementations are described herein by way of example, those skilled in the art will recognize that the implementations are not limited to the examples or drawings described. It should be understood that the drawings and detailed description thereto are not intended to limit implementations to the particular form disclosed but, on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION

This disclosure describes systems and techniques to prevent dissemination of sensitive information provided to a Large Language Model (LLM) using retrieval-augmented generation (RAG). For example, the LLM may use information provided by RAG from a proprietary data source to respond to requests. A service may desire to prevent extended portions of the proprietary data source from being reproduced as a means to prevent distribution of sensitive information, such as confidential information, financial information, personal information, and/or legally protected data (e.g., copyright protected, subject to a license agreement, etc.). The service may use techniques discussed below to ensure that extended portions of the data source are not reproduced in a response. Without these safeguards, an LLM may copy extended portions of the source document to satisfy a request, thereby revealing sensitive information.

To safeguard copy protection, the data source provided to the LLM by way of RAG may be sharded into multiple shards. In some embodiments, the data source may be sharded into a first shard and a second shard. The data source may be sharded to include first portions of a file in the first shard but not in the second shard while including second portions in the second shard and not in the first shard. This process creates a partition between the data included in the data source. When multiple files are included in the data source, the sharding may assign some files to the first shard and other files to the second shard. When some data sources include non-sensitive data, these files may be provided to all shards or may also be divided among the shards. This sharding process reduces a risk that the LLM is too closely tied to any specific data and thus replicates an extended amount of that data.

After creation of the shards, queries may be submitted to the LLM with instructions to use data in one of the shards (but not both) to generate tokens associated with probabilities from each shard. For example, a first query may be submitted to the LLM implemented with the RAG with the first shard to determine a first probability associated with a token used to determine a next word in the generative text. Similarly, a second query may be submitted to the LLM implemented with the RAG with the second shard to determine a second probability associated with the token used to determine the next word in the generative text. By querying the LLM separately for each shard, the LLM is limited to information in the respective shard to generate the tokens and respective probabilities.

In accordance with some embodiments, combined probabilities may be determined for same tokens returned from the LLM via processing of data with the different shards. For example, the LLM may return a first token with a first probability in response to a first query and may return the token with a second probability in response to a second query. A service may then create a combined probability for the token based on the first probability and the second probability. The combined probability may be between the first probability and the second probability. The combined probability may reduce a likelihood that a higher probability returned from one of the queries results in selection of the corresponding token, which may occur when the underlying source data includes highly relevant data which, without safeguards, may result in extended use of the data and may reveal sensitive information and/or violate a policy (e.g., reproducing copyrighted material, etc.). The combined probability may be created in many different ways, such as using weighted averages, random numbers, smoothing functions, and so forth.

In various embodiments, other safeguards may be employed to prevent more than a threshold number of consecutive tokens from being selected from the LLM using the same shard. For example, if the threshold number is four and four consecutive tokens are selected based on results from the LLM using tokens generated using the first shard, then the next token may be selected from results from the LLM using tokens generated using the second shard.

After the combined probability is determined, a next token may be selected from various tokens each having different combined probabilities. After a token is selected, a corresponding word associated with the token may be implemented in a result of generative text. By repeating this process, a service may generate a response that prevents or reduces a likelihood of output of sensitive information in generated text created using tokens created from different shards.

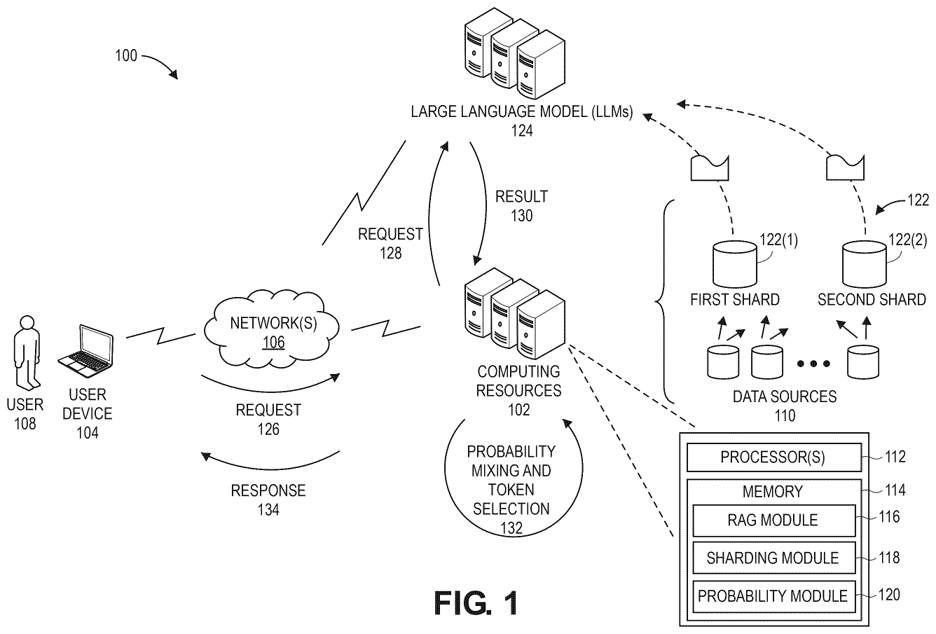

Various embodiments described herein provide copy protection to prevent extended output of sensitive data in results processed by an LLM implemented with RAG. While examples that follow discuss implementation with one or more LLMs, other machine learning resources may benefit from these techniques, such as generative artificial intelligent (GenAI) systems and other types of machine learning systems capable of responding to queries using RAG inputs or similar inputs. Additional details describing systems and techniques to implement these features are provided below with reference to FIGS. 1-12.

FIG. 1 is a schematic diagram of an illustrative environment 100 to prevent output of sensitive data in generative text provided by a large language model (LLM) implemented with retrieval-augmented generation (RAG), according to an implementation. The environment 100 may include computing resources 102 to provide data to a user device 104 via one or more networks 106 in response to a request. The networks may be any type of wired and/or wireless networks configured to facilitate exchange of data between electronic devices. The request may be input by a user 108 and sent to the computing resources 102 via the networks 106 for further processing to determine a response to provide to the user device 104.

The computing resources 102 may be associated with or include data sources 110. The data sources 110 may include proprietary data and/or other types of data and may not be available to some other resources. For example, the data sources 110 may be under control of the computing resources 102, which may determine which other resources access information in the data sources 110. The data sources may include sensitive data, such as confidential information, financial information, personal information, legal information, and/or other types of protected or sensitive types of information.

The computing resources may include one or more processor(s) 112 and memory 114 to store computing instructions. The memory may store at least a RAG module 116, a sharding module 118, and a probability module 120. However, the memory 114 may store other modules, components, and/or code to cause performance of the various tasks performed by the computing resources 102. The RAG module 116 may provide data from the data sources 110 and/or from shards 122 to one or more LLMs 124 with instructions to provide certain data to the computing resources 102. The sharding module 118 may shard the data sources 110 into at least a first shard 122(1) and a second shard 122(2), which each include different portions of the data in the data sources 110. The probability module 120 may manipulate, mix, combine, or otherwise process probabilities associated with tokens returned from the one or more LLMs 124. The tokens may correspond to words, text, characters, numbers, images, video, sounds, and/or other media items. For example, a first token returned by an LLM may correspond to a word while a second token may correspond to an image, possibly at a later point in generation of a response. An example below further illustrates possible functions of the various modules discussed above.

In a first example, the user 108 may submit, via the user device 104, a request 126 to the computing resources 102 for generative text about a topic, such as a new product offered by a service. Meanwhile, the computing resources may include one or more files or documents providing information about the new product and included in the data sources 110. However, this information may not be generally available to the one or more LLMs 124 or used to train the LLM as a knowledge resource. In order to have the LLM evaluate the information about the new product in the data sources 110, the computing resources may provide the information to the LLM via the RAG module 116 along with instructions for the request 126.

In accordance with various embodiments, the computing resources 102 may shard the data sources 110 into the first shard 122(1) and the second shard 122(2) using the sharding module 118 to allocate information about the new product into one of the shards 122. As a result, the first shard 122(1) will include different information than the second shard 122(2). The computing resources 102 may then use the RAG module 116 to submit a request 128, via a query, to the LLM along with data in one of the shards 122. For example, the computing resources 102 may send a first query as part of the request 128 to the one or more LLMs 124 with at least some data from the first shard 122(1) to get a first portion of a result 130. The result 130 may include first tokens with associated first probabilities. The computing resources 102 may send a second query as part of the request 128 to the one or more LLMs 124 with at least some data from the second shard 122(2) to get a second portion of the result 130. The result 130 may include second tokens with associated second probabilities.

The probability module 120 may, for each matching token returned from the LLM as part of the result 130, combine the probabilities generated for the token based on use of the different shards 122 as input to the one or more LLMs 124. The combined probability may be a probability between a first probability determined using data from the first shard 122(1) and a second probability determined using data from the second shard 122(2). The computing resources 102 may perform a probability mixing and token selection process 132, at least in part using the probability module 120, to generate a response 134 to provide to the user device 104. By combining the probabilities, the computing resources 102 may reduce a likelihood that extended portions of data from a same shard may be selected to create generative text, thereby reducing a likelihood of providing sensitive information in a response 134 provided to the user device 104.

Returning to the example of the new product, the sharding of the data sources 110 may cause information about the new product to be divided into the first shard 122(1) and the second shard 122(2), which may then produce different portions of the result 130. The combining of probabilities may then lessen a chance that consecutive tokens are repeatedly selected from a same data source, which in turn reduces direct copying of data from the data sources 110. In contract, when the RAG module 116 sends a request to the LLM with access to all the data sources 110, then direct copying of results may occur if certain data in the data sources 110 is highly relevant to the request 128, creating high probability results of tokens returned in the result 130. In these later instances, no combined probability is created because the result 130 is generated from a single query. In some instances, when the RAG module 116 uses the shards 122 in the requests to the LLM, some tokens provided in a first portion of the result 130 may not be included in a second portion of the result 130, and vice versa. These tokens may have a corresponding probability adjusted to create a combined probability, such as a combined probability of between a returned probability from the one or more LLMs 124 and zero probability.

In some embodiments, additional safeguards may be used to prevent or limit copying extended amounts of information from a single data source. For example, a safeguard may prevent selection of a threshold number of tokens from a same shard of the shards 122. In various embodiments, a smoothing function may be applied to some or all probability values returned from the one or more LLMs 124 or applied to some or all of the combined probability values to level or otherwise adjust probability values prior to selection of a next token. Ultimately, the response 134 may include text that incorporates a next word selected based on the combined probability of a token returned by the one or more LLMs 124 via the processing of data in the shards 122. The generative text may limit extended copying of text from the data sources 110 based on the operations of the sharding module 118 and the probability module 120. Further description of these modules and processing is described next.

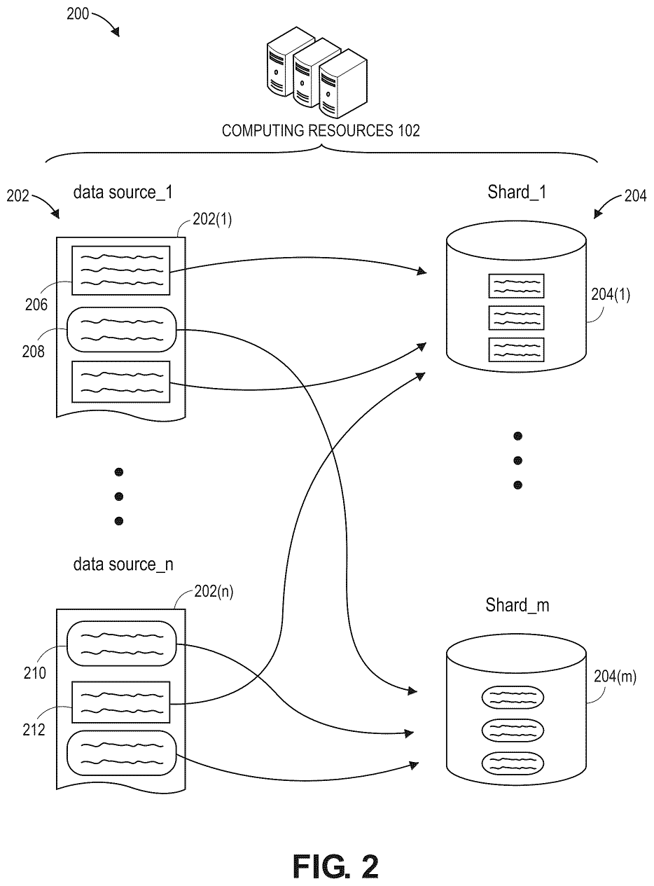

FIG. 2 is a schematic diagram showing example shards 200 resulting from sharding of data sources, according to an implementation. The example shards 200 may be created by the computing resources 102, such as by implementation of the sharding module 118 described above with reference to FIG. 1.

The computing resources 102 may include or have access to various data sources 202. The data sources may include a first data source 202(1) through a last data source 202(n). Any number of data sources may be used. The data in the data sources 202 may be processed by the sharding module 118 to create shards 204. The shards 204 may include a first shard 204(1) through a last shard 204(m). In some embodiments, two shards may be created as the shards 204.

The sharding module 118 may shard the data sources 202 in different ways. In some embodiments, the sharding module 118 may allocate or shard the first data source 202(1) (e.g., a document, a file, etc.) to the first shard 204(1) and allocate the last data source 202(n) to the last shard 204(m). In these instances, entire files, documents, or individual sources may be sharded to one of the shards 204, but not multiple ones of the shards 204. In various embodiments, portions of data sources 202 may be sharded to different ones of the shards 204. For example, the first data source 202(1) may include a first portion 206 and a second portion 208. The sharding module 118 may allocate or shard the first portion 206 to the first shard 204(1) and the second portion 208 to the last shard 204(m). The last data source 202(n) may include a third portion 210 and a fourth portion 212. The sharding module 118 may allocate or shard the third portion 210 to the last shard 204(m) and the fourth portion 212 to the first shard 204(1). The first portion 206, the second portion 208, the third portion 210, and the fourth portion 212 may be selected as paragraphs of text, pages, tables, predetermined amounts of data (e.g., rows of data, bytes of data), and/or by using other divisions of information included in a single data sources.

In various embodiments, some data sources may be included in multiple shards or all shards of the shards 204. For example, sensitive data may be sharded as described above to be allocated or shard to a single shard of the shards 204. Non-sensitive data may be included in multiple shards of the shards 204 because there is no concern or less of a concern of providing extended copying of information from the non-sensitive data.

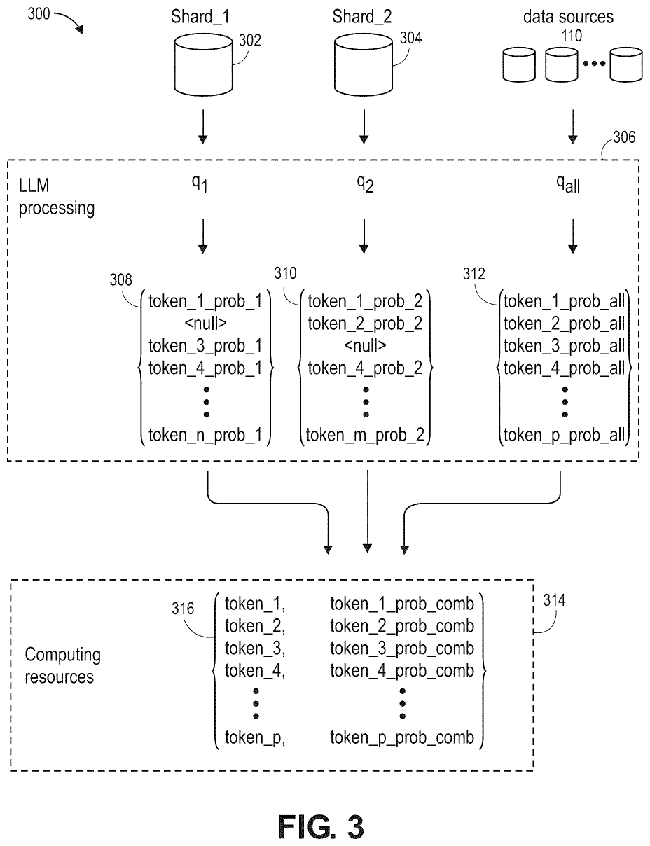

FIG. 3 is a schematic diagram showing example token probabilities 300 used to create combining probabilities of tokens based on queries using different shards, according to an implementation. The sharding module 118 may create a first shard 302 and a second shard 304, and possibly other shards, using data from the data sources 110, as discussed with refence to FIG. 2. The computing resources 102 as shown in FIG. 1, may submit queries to the one or more LLMs 124 to obtain tokens and corresponding probabilities for those tokens via a process 306. For example, a first query may be submitted to the LLM for implementation with RAG using the first shard 302 to create a first token/probability result 308. A second query may be submitted to the LLM for implementation with RAG using the second shard 304 to create a second token/probability result 310. In some embodiments, a third query may be submitted to the LLM for implementation with RAG using the data sources 110 to create a third token/probability result 312. However, the process 306 may not submit the third query or use the third token/probability result 312 in some implementations.

In various embodiments, the computing resources 102 may use the probability module 120 to perform a process 314 to combine probabilities of same tokens using the first token/probability result 308 and the second token/probability result 310 to create a combined token/probability result 316. In some embodiments, the probability module 120 may combine probabilities of same tokens based on at least one of the first token/probability result 308, the second token/probability result 310, or the third token/probability result 312 to create a combined token/probability result 316. Each of the probabilities may be associated with a respective token.

As a first example, the probability module 120 may combine probabilities of the first token/probability result 308 and the second token/probability result 310 to create the combined token/probability result 316 using a weighted average. The combined token/probability result 316 may be a weighted average of respective probabilities of a same token. When a token is only represented in one of the results from the process 306 (e.g., when a <null value> is present for a token), the token in the combined result may include a probability between a returned value and zero, for example. The weight may be any value applied to one or both probability values to adjust the probability values. For example, the weight may be a randomly generated value between zero and one.

As a second example, the probability module 120 may combine probabilities of the first token/probability result 308 or the second token/probability result 310 with the third token/probability result 312 to create the combined token/probability result 316. For example, the combined token/probability result 316 may be constrained by a probability value in the third token/probability result 312, such as via implementation of an upper limit for the probability value dictated by values in the third token/probability result 312. In some embodiments, the probability values in the combined token/probability result 316 may be adjusted using a smoothing function to reduce probability values or increase some probability values relative to other probabilities corresponding to the same token.

The combined token/probability result 316 may include a listing of each unique token returned from the process 306 and a corresponding combined probability value for that token. For example, for a token_1, a probability represented by token_1_prob_1 may include a first value of X in the first token/probability result 308 while a probability represented by token_1_prob_2 may include a second value of Y in the second token/probability result 310. The token_1 may have a combined probability between X and Y in the combined token/probability result 316.

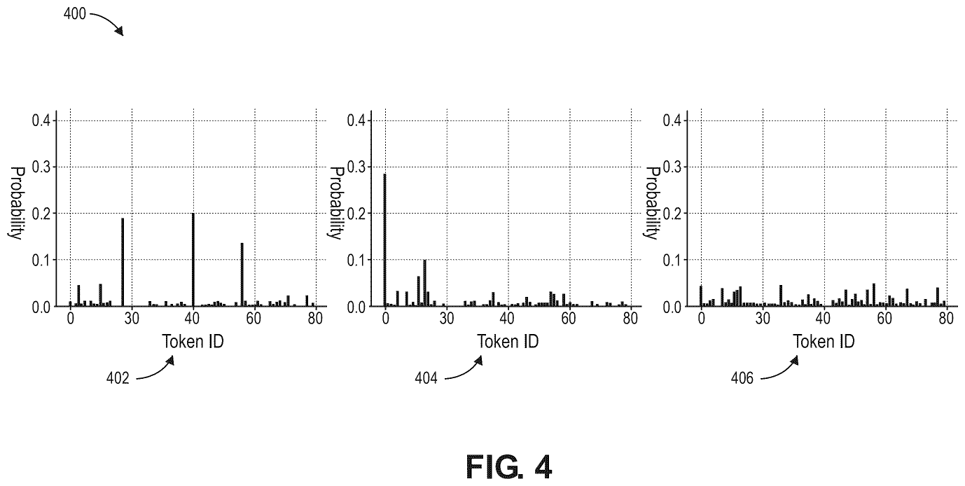

FIG. 4 is a schematic diagram showing example graphs 400 of probabilities generated using a smoothing function, according to an implementation. In the example graphs, 80 tokens are plotted with respect to corresponding probabilities for each token. More or fewer tokens may be returned by the LLM. The values in the graphs are exemplary and only for discussion purposes.

A first example graph 402 may include a plot of sample tokens and probabilities returned by the LLM implemented with RAG using the first shard 302 discussed above with reference to FIG. 3. As shown in the first example graph 402, some tokens may include higher probabilities than other tokens, such as tokens 27, 39, and 53 that have relatively higher probabilities as compared to other tokens in the first example graph 402.

A second example graph 404 may include a plot of sample tokens and probabilities returned by the LLM implemented with RAG using the second shard 304 discussed above with reference to FIG. 3. As shown in the second example graph 404, some tokens may include higher probabilities than other tokens, such as tokens 0 and 20 that have relatively higher probabilities as compared to other tokens in the second example graph 404.

A third example graph 406 may include a plot of sample tokens and combined probabilities after processing by the probability module 118 as discussed above with reference to FIG. 3. As shown in the third example graph 406, tokens 0, 20, 27, 39, and 53 have reduced probabilities as a result of the combining performed by the probability module 118. The probabilities shown in the third example graph 406 may have been smoothed using a smoothing algorithm to reduce probabilities of respective tokens, possibly using a weight average, a random number, comparison with probability results generated from RAG processing with the entire data source (e.g., the third token/probability result 312), or other algorithms.

Ultimately, a token may be selected from the tokens included in the third example graph based on the respective probabilities of those tokens. Selection of the token may be based on a highest probability or based on other factors, such as a second or third highest probability, based on where the token originated (e.g., from which shard), or based on other factors. The selected token may be associated with a next word in generative text, which may be provided to the user device 104 as the response 134 as discussed with reference to FIG. 1.

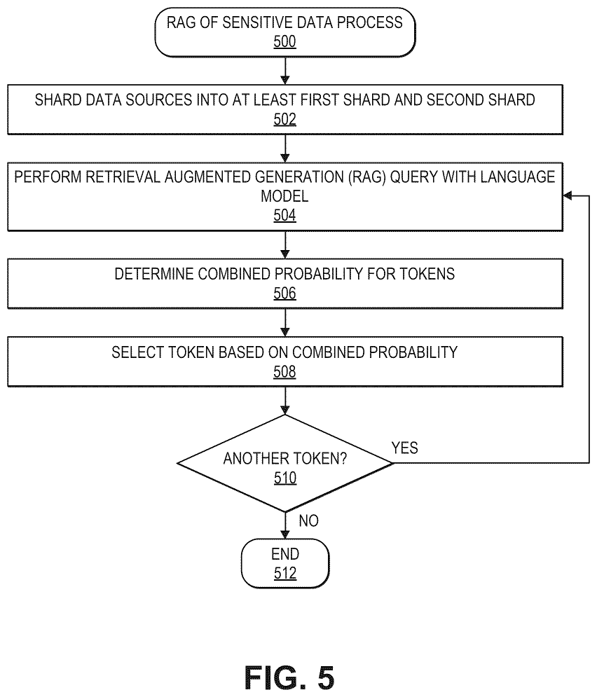

FIG. 5 is a flow diagram of an example process 500 to prevent output of sensitive data in generative text provided by an LLM implemented with RAG, in accordance with disclosed implementations. The example process of FIG. 5 and each of the other processes and sub-processes discussed herein may be implemented in hardware, software, or a combination thereof. In the context of software, the described operations represent computer-executable instructions stored on one or more computer-readable media that, when executed by one or more processors, perform the recited operations. Generally, computer-executable instructions include routines, programs, objects, components, data structures, and the like that perform particular functions or implement particular abstract data types.

The computer-readable media may include non-transitory computer-readable storage media, which may include hard drives, floppy diskettes, optical disks, CD-ROMs, DVDs, read-only memories (ROMs), random access memories (RAMs), EPROMS, EEPROMs, flash memory, magnetic or optical cards, solid-state memory devices, or other types of storage media suitable for storing electronic instructions. In addition, in some implementations, the computer-readable media may include a transitory computer-readable signal (in compressed or uncompressed form). Examples of computer-readable signals, whether modulated using a carrier or not, include, but are not limited to, signals that a computer system hosting or running a computer program can be configured to access, including signals downloaded through the Internet or other networks. Finally, the order in which the operations are described is not intended to be construed as a limitation and any number of the described operations can be combined in any order and/or in parallel to implement the routine. Likewise, one or more of the operations may be considered optional. Various operations from different processes may be combined in accordance with various embodiments.

The process 500 may begin by sharding data sources into at least a first shard and a second shard, as in 502. For example, the sharding module 118 may access data sources 110 (described with reference to FIG. 1) that possibly include proprietary and/or sensitive data, such as confidential data, financial data, personal data, copyrighted data, data subject to a license agreement, private data, or other data. The sharding module 118 may shard the data sources 110 such that first portions of the data sources are allocated to a first shard omitted from the second shard while second portions of the data sources are allocated to a second shard and omitted from the first shard.

The computing resources 102 may submit queries to the one or more LLMs 124 using RAG with one of the shards to obtain tokens with associated probabilities from the respective shard, as in 504. For example, the computing resources 102 may submit a first query to the one or more LLMs 124 implemented with the RAG with the first shard to determine a first probability associated with a token used to determine a next word in the generative text. The computing resources 102 may submit a second query to the one or more LLMs 124 implemented with the RAG with the second shard to determine a second probability associated with the token. Of course, each query may return multiple tokens, each having an associated probability.

The probability module 120 may determine combined probability for the token returned in the operation 504, as in 506. The probability module 120 may also determine other combined probabilities for respective other tokens returned in the operation 504. The combined probabilities may be based on results based on one of the shards. In some instances, a query may include results from the data sources and may be used to determine the combined results, such as to establish an upper limit or a weighted upper limit for a probability value for a token. As an example, a token may include probability values from the first shard, the second shard, and the data sources, respectively, as follows: {0.01, 0.34, 0.28}. The probability value generated using the data sources of {0.28}, referred to here as “prob_all” may be subjected to a weighting value X. X may be a random number within a range of values and used to reduce the value of prob_all. If X is 0.8, then prob_all would be calculated as {0.28×0.08=0.224}. The value {0.224} may be used as an upper limit for the combined probability of this token; thus the combined probability of the token may be a number less than or equal to {0.224} in this example.

A token may be selected as a next token in generative text based on the combined probability or combined probabilities determined in the operation 506, as in 508. The token may be selected that includes a highest probability, a second highest probability, or other ranked probability. In some embodiments, other selection logic may be implemented to select the token, such as enforcement of a threshold rule for a number of consecutive tokens that can be selected from a same shard. The next token may be associated with a word in the generative text.

A decision operation may determine whether to generate another token for selection for inclusion in the generative text, as in 510. When another token is to be selected, following the “yes” route from the decision operation 510, the process 500 may advance to the operation 504 and continue processing accordingly. When no further tokens are to be selected, following the “no” route from the decision operation 510, the process 500 may advance to the operation 512 and end.

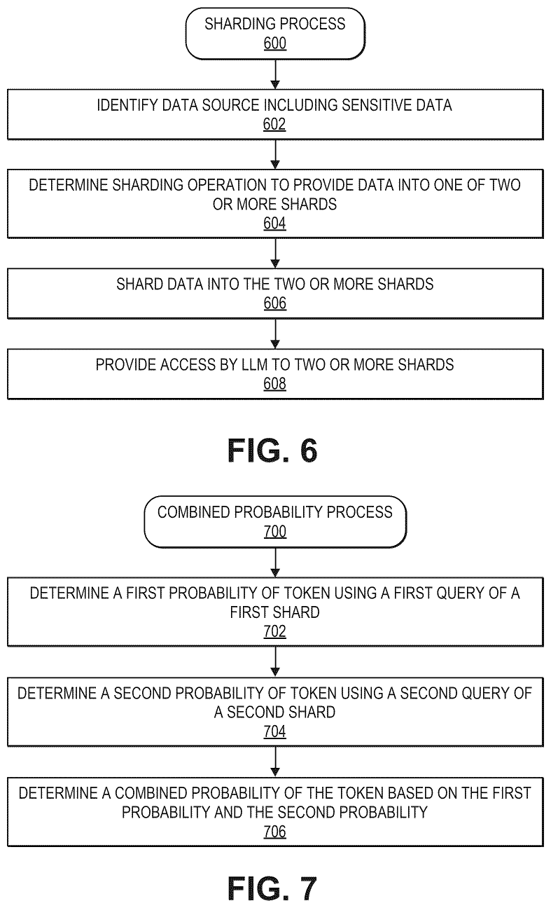

FIG. 6 is a flow diagram of an example process 600 to shard a data source into two or more shards, according to an implementation. The process 600 may include actions performed by the sharding module 118 described above with reference to FIG. 1.

The process 600 may begin by identifying a data source that includes sensitive data, as in 602. For example, the data source may be a subset of a larger data source or may encompass all of the larger data source. The data source may be determined to include sensitive data if the data includes proprietary data, confidential data, financial data, personal data, copyrighted data, data subject to a license agreement, private data, or other data.

The sharding module 118 may determine a sharding operation to provide data into one of two or more shards, as in 604. The sharding process may determine whether to divide files into portions for distribution to the different shards or to provide entire files to different shards, assuming multiple documents are included in the sensitive data source. If a file is divided up into portions, a determination of what to include in the portion may be determined. For example, a text document may be divided into portions based on paragraphs of text, a threshold number of consecutive words, pages, and/or other factors. A database may be divided into portions based on rows of data, tables in the database, or other factors.

The data source may be sharded into the two or more shards in accordance with the determination of the operation 604, as in 606. The sharding module 118 may apply the sharding operation to identify the portions and the respective shard to allocate the portion to. As a result, the created shards will include different information. In some embodiments, non-sensitive data sources may be available. The sharding module 118 may allocate data from these non-sensitive data sources to multiple shards or all shards allowing duplication of the non-sensitive data across multiple shards unlike the sharding of the sensitive data that prevents duplication across multiple shards.

The resulting shards may be made available to the one or more LLMs 124, as in 608. The computing resources 102 may send a query to the one or more LLMs 124 to determine a next token for generative text and using RAG to specify a shard as input data for the query. For example, the computing resources 102 may submit a first query to the one or more LLMs 124 implemented with the RAG with the first shard to determine a first probability associated with a token used to determine a next word in the generative text. The computing resources 102 may submit a second query to the one or more LLMs 124 implemented with the RAG with the second shard to determine a second probability associated with the token. Of course, each query may return multiple tokens, each having an associated probability.

FIG. 7 is a flow diagram of an example process 700 to combine probabilities of a token resulting from queries of different shards, according to an implementation. The process 700 may include actions performed by the probability module 120 described above with reference to FIG. 1.

The process 700 may begin by determining a first probability of a token in response to a first query submitted to the one or more LLMs 124 with RAG allocation of the first shard, as in 702. The first query may return multiple first tokens, each with a respective probability.

A second probability of the token may be determined from a response to a second query submitted to the one or more LLMs 124 with RAG allocation of the second shard, as in 704. Again, the second query may return multiple second tokens, each with a respective probability. In some instances, the first tokens may include one or more tokens that are not included in the second tokens while the second tokens may include one or more tokens not included in the first tokens.

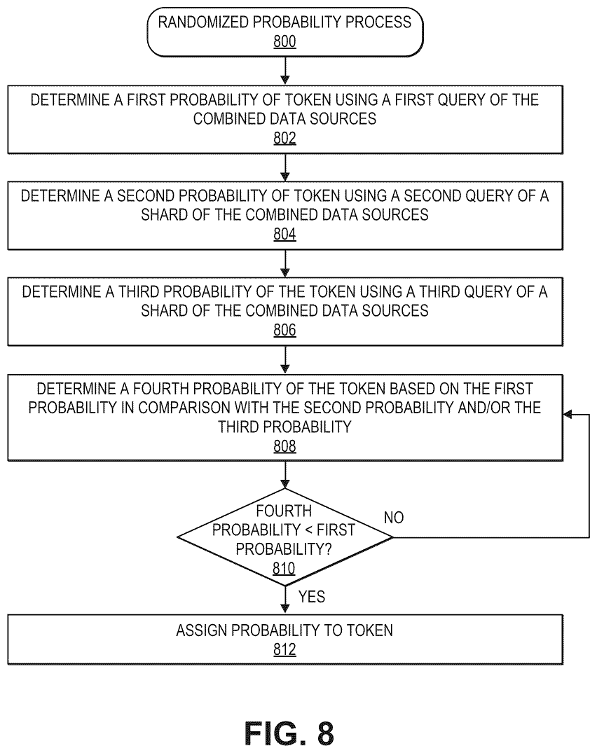

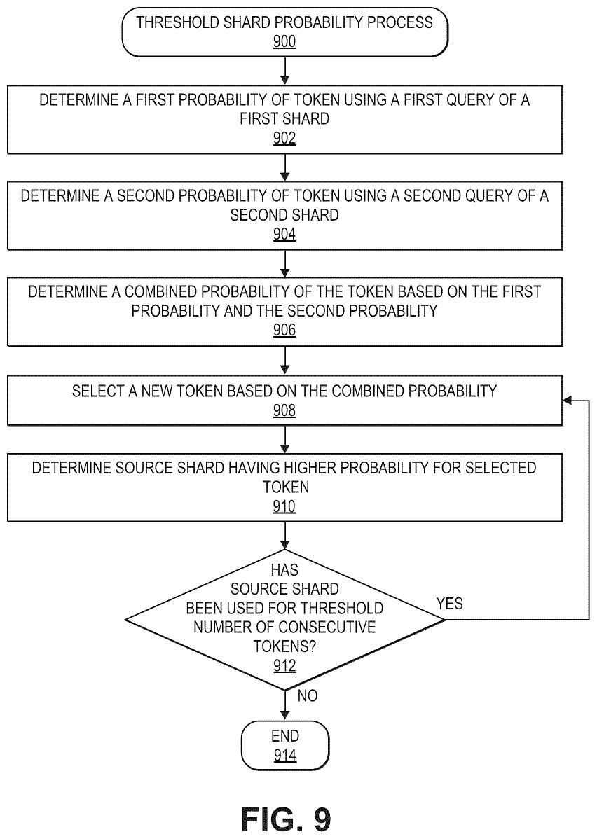

The probability module 120 may determine a combined probability for the token based on results from at least the first query and the second query, as in 706. The combined probability may be determined based on a first probability of the first token and a second probability of the second token, possibly using a weighted average. In some implementations, other logic and/or conditions may be used to select or determine the combined probability. Examples of other logic are discussed next with reference to FIGS. 8 and 9. The probability module 120 may create the combined probability in countless ways such that the combined probability is different than a probability returned for that token in a query to the LLM using RAG with the entire data source. As discussed above, creation of the combined probability creates copy protection to prevent extended selection of tokens from a same source.

FIG. 8 is a flow diagram of an example process 800 to combine probabilities of a token resulting from queries of different shards and a query of the data source, according to an implementation. The process 800 may include actions performed by the probability module 120 described above with reference to FIG. 1.

The process 800 may begin by determining a first probability of a token in response to a first query submitted to the one or more LLMs 124 with RAG allocation of the combined data sources (i.e., the data source 110 shown in FIG. 1), as in 802. The first query may return multiple first tokens, each with a respective probability.

A second probability of the token may be determined from a response to a second query submitted to the one or more LLMs 124 with RAG allocation of the first shard, as in 804. The second query may return multiple second tokens, each with a respective probability.

A third probability of the token may be determined from a response to a third query submitted to the one or more LLMs 124 with RAG allocation of the second shard, as in 806. The third query may return multiple third tokens, each with a respective probability. In some instances, the second tokens may include one or more tokens that are not included in the third tokens while the third tokens may include one or more tokens not included in the second tokens. The first tokens may include all possible tokens unless the LLM outputs a limited number of tokens or for other reasons.

A fourth probability may be determined based on a comparison of the first probability of the token and at least one of the second probability or the third probability of the token, as in 808. The comparison may include generating a random multiplier, such as using a “k” value. Algorithm 1, below, provides an example algorithm to generate the fourth probability.

Algorithm 1:

```
Input: a query x; a model q; a threshold k ≥ 0.
Learning: Call rag-default(x, q) to obtain qₐₗₗ; Call rag-sharded-safe(x, q) to obtain q₁
      and q_{₂}.
Return pₖ: where pₖ is specified as:
while True do:
      Sample y ~ qₐₗₗ (·|x) and
      $return y with probability min \{ 1 , {min}_{i ∈ \{ 1 , 2 \}} \{ {2}^{k} \frac{{q}_{i} ( y \vert x )}{{q}_{all} ( y \vert x )} \} \}$
end while
```

A decision operation may determine whether the fourth probability is less than the first probability, as in 810. When the fourth probability is not less than the first probability, following the “no” route from the decision operation 810, the process 800 may advance to the operation 808 and continue processing accordingly. For example, the operation 808 may be calculated with a different token, randomized weight, or other output the change an output of the operation 808. Returning to the decision operation 810, when the fourth probability is less than the first probability, following the “yes” route from the decision operation 810, the process 800 may advance to an operation 812.

The probability module 120 may assign the fourth probability selected at the operation 808 to the token, as in 812. This assignment may create a unique and possibly randomized probability for the token. The process 800 may create multiple probabilities, each for different tokens, using the process 800 or a variation of the process 800.

FIG. 9 is a flow diagram of an example process 900 to implement a threshold to limit generation of consecutive tokens from a same shard, according to an implementation. The process 900 may include actions performed by the probability module 120 described above with reference to FIG. 1.

The process 900 may begin by determining a first probability of a token in response to a first query submitted to the one or more LLMs 124 with RAG allocation of the first shard, as in 902. The first query may return multiple first tokens, each with a respective probability.

A second probability of the token may be determined from a response to a second query submitted to the one or more LLMs 124 with RAG allocation of the second shard, as in 904. Again, the second query may return multiple second tokens, each with a respective probability. In some instances, the first tokens may include one or more tokens that are not included in the second tokens while the second tokens may include one or more tokens not included in the first tokens.

The probability module 120 may determine a combined probability for the token based on results from at least the first query and the second query, as in 906. The combined probability may be determined based on a first probability of the first token and a second probability of the second token. In some embodiments, the combined probability may be determined by a weighted average or other calculated value using at least the first probability and the second probability.

A new token (or next token) may be selected to create generative text based on the combined probability from the operation 906, as in 908. The token with the highest combined probability may be selected or the token may be selected based on other logic (e.g., second highest, nth highest, etc.).

A source shard that provides the token or has a higher probability of the shards that provide the token may be determined as in 910. By tracking the shard that originates the token or has the higher probability, limits may be implemented to ensure that a threshold number of consecutive tokens do not originate from a same shard which would result in revealing sensitive information, copyright violation, or other undesirable outcomes.

A decision operation may determine whether a source shard determined by the operation 910 has been used for a threshold number of consecutive tokens, as in 912. When the source shard has been used for a threshold number of consecutive tokens, following the “yes” route from the decision operation 912, the process 900 may advance to the operation 908 and continue processing accordingly. For example, after returning to the operation 908, the operation may select a different token that is not from the same shard as the prior selection. Returning to the decision operation 912, if the source shard has not been used for a threshold number of consecutive tokens, following the “no” route from the decision operation 912, the process 912 may advance to an operation 914. The process 900 may end at 914. In some embodiments, the process 900 may continue processing other tokens to determine next tokens for generative text.

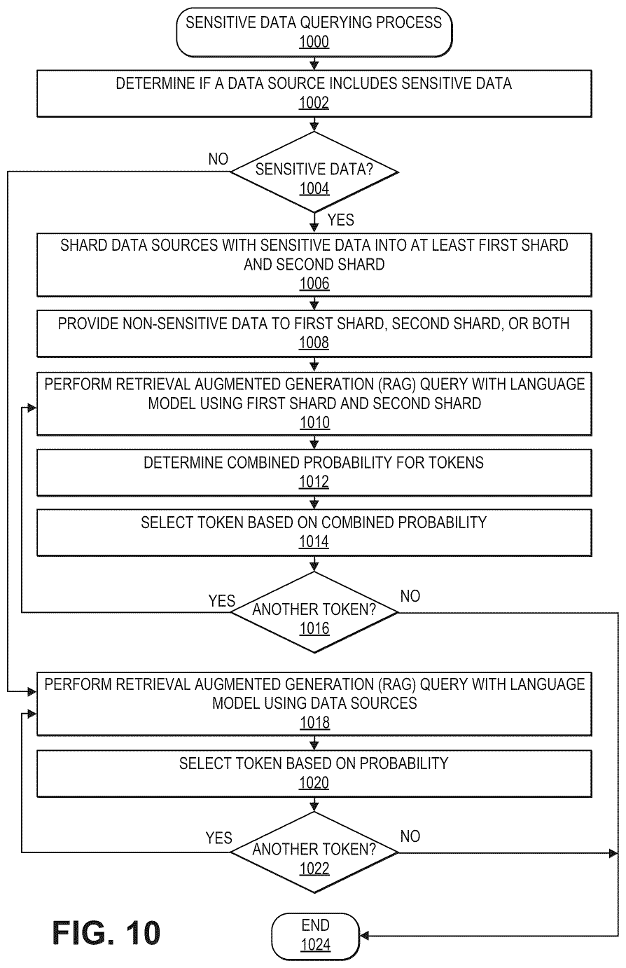

FIG. 10 is a flow diagram of another example process 1000 to prevent output of sensitive data in generative text provided by an LLM implemented with RAG, in accordance with disclosed implementations. The processes may be implemented at least in part by the computing resources 102 described with reference to FIG. 1.

The process 1000 may begin by determining if a data source provided to an LLM via RAG includes sensitive data, as in 1002. For example, the data source may include proprietary data that may include at least some sensitive data, such as confidential information, financial information, copyrighted information, information subject to a license agreement, personal information, privacy information, and/or other information deemed desirable to protect.

A decision operation may determine whether the data sources include sensitive data, as in 1004. When the data sources include sensitive data, following the “yes” route from the decision operation 1004, the process 1000 may advance to an operation 1006 and continue processing accordingly. When the data sources do not include sensitive data, following the “no” route from the decision operation 1004, the process 1000 may advance to an operation 1018, described below.

Portions of data sources including sensitive data may be sharded into at least a first shard or a second shard, as in 1006. For example, the sharding module 118 may access data sources 110 (described with reference to FIG. 1) that include at least some sensitive data. The sharding module 118 may shard the data sources 110 such that first portions of the data sources are allocated to a first shard omitted from the second shard while second portions of the data sources are allocated to a second shard and omitted from the first shard.

Data sources including non-sensitive data may be sharded into at least a first shard and a second shard, as in 1008. For example, the sharding module 118 may access data sources 110 (described with reference to FIG. 1) that include non-sensitive data. The sharding module 118 may shard the non-sensitive data to be included in each of the shards.

The computing resources 102 may submit queries to the one or more LLMs 124 using RAG with one of the shards to obtain tokens with associated probabilities from the respective shard, as in 1010. For example, the computing resources 102 may submit a first query to the LLM 124 implemented with the RAG with the first shard to determine a first probability associated with a token used to determine a next word in the generative text. The computing resources 102 may submit a second query to the one or more LLMs 124, or to a different LLM, implemented with the RAG with the second shard to determine a second probability associated with the token. Of course, each query may return multiple tokens, each having an associated probability. In some embodiments, the first query may be submitted to a first LLM and the second query may be submitted to a second LLM. The second LLM may be a copy of the first LLM or a different LLM, such as an LLM implemented by a different entity. In various embodiment, queries may be assigned to different LLMs randomly or using other algorithms so that data from a certain shard is not always processed by the same LLM.

The probability module 120 may determine combined probability for the token returned in the operation 1010, as in 1012. The probability module 120 may also determine other combined probabilities for respective other tokens returned in the operation 1010. The combined probabilities may be based on results based on one of the shards. In some instances, a query may include results from the data sources and may be used to determine the combined results, such as to establish an upper limit or a weighted upper limit for a probability value for a token.

A token may be selected as a next token in generative text based on the combined probability or combined probabilities determined in the operation 1012, as in 1014. The token may be selected that includes a highest probability, a second highest probability, or other ranked probability. In some embodiments, other selection logic may be implemented to select the token, such as enforcement of a threshold rule for a number of consecutive tokens that can be selected from a same shard. The next token may be associated with a word in the generative text.

A decision operation may determine whether to generate another token for selection for inclusion in the generative text, as in 1016. When another token is to be selected, following the “yes” route from the decision operation 1016, the process 1000 may advance to the operation 1010 and continue processing accordingly. When no further tokens are to be selected, following the “no” route from the decision operation 1016, the process 1000 may advance to the operation 1024 and terminate.

Returning to the decision operation 1004, when the data sources do not include sensitive data, following the “no” route from the decision operation 1004, the process 1000 may advance to an operation 1018. The computing resources 102 may submit one or more queries to the one or more LLMs 124 using RAG with all of the data sources, which have non-sensitive data, to obtain tokens with associated probabilities, as in 1018.

A token may be selected as a next token in generative text based on the probability or probabilities determined in the operation 1018, as in 1020. The token may be selected that includes a highest probability. However, other selection logic may be implemented at the operation 1020.

A decision operation may determine whether to generate another token for selection for inclusion in the generative text, as in 1022. When another token is to be selected, following the “yes” route from the decision operation 1022, the process 1000 may advance to the operation 1018 and continue processing accordingly. When no further tokens are to be selected, following the “no” route from the decision operation 1022, the process 1000 may advance to the operation 1024 and terminate.

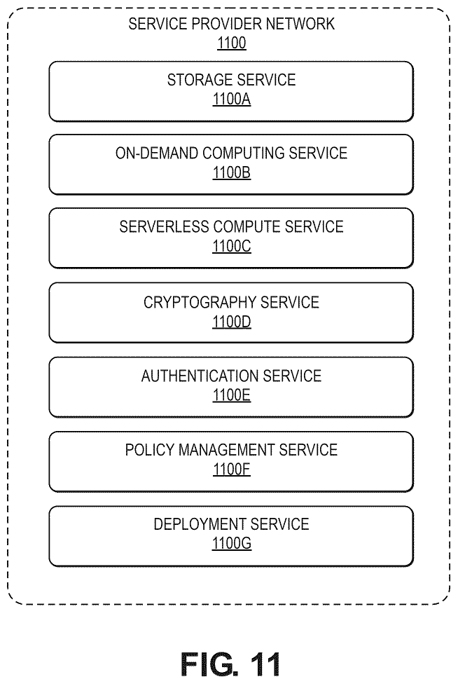

FIG. 11 is a system services diagram that shows aspects of several services that can be provided by and utilized within a service provider network 1100, which can be configured to implement the various technologies disclosed herein. The service provider network 1100 can provide a variety of services to users including, but not limited to, a computing resource or computing instance performing one or more functions thereof, a storage service 1100A, an on-demand computing service 1100B, a serverless compute service 1100C, a cryptography service 1100D, an authentication service 1100E, a policy management service 1100F, and a deployment service 1100G. The service provider network 1100 can also provide other types of computing services, some of which are described below.

It is also noted that not all configurations described include the services shown in FIG. 11 and that additional services can be provided in addition to, or as an alternative to, the services explicitly described herein. Each of the systems and services shown in FIG. 11 can also expose web service interfaces that enable a caller to submit appropriately configured application program interface (API) calls to the various services through web service requests. The various web services can also expose GUIs, command line interfaces (“CLIs”), and/or other types of interfaces for accessing the functionality that they provide. In addition, each of the services can include service interfaces that enable the services to access each other. Additional details regarding some of the services shown in FIG. 11 will now be provided.

The storage service 1100A can be a network-based storage service that stores data obtained from users of the service provider network 1100 and/or from computing resources in the service provider network 1100. The data stored by the storage service 1100A can be obtained from computing devices of users, the computing service, or other resources. The data stored by the storage service 1100A may include the data sources 110.

The on-demand computing service 1100B can be a collection of computing resources configured to instantiate VM instances and to provide other types of computing resources on demand. For example, a user of the service provider network 1100 can interact with the on-demand computing service 1100B (via appropriately configured and authenticated API calls, for example) to provision and operate virtual machine (VM) instances that are instantiated on physical computing devices hosted and operated by the service provider network 1100. The VM instances can be used for various purposes, such as to operate as servers supporting the network services described herein, a web site, to operate business applications or, generally, to serve as computing resources for the user.

Other applications for the VM instances can be to support database applications, electronic commerce applications, business applications and/or other applications. Although the on-demand computing service 1100B is shown in FIG. 11, any other computer system or computer system service can be utilized in the service provider network 1100 to implement the functionality disclosed herein, such as a computer system or computer system service that does not employ virtualization and instead provisions computing resources on dedicated or shared computers/servers and/or other physical devices.

The serverless compute service 1100C is a network service that allows users to execute code (which might be referred to herein as a “function”) without provisioning or managing server computers in the service provider network 1100. Rather, the serverless compute service 1100C can automatically run code in response to the occurrence of events. The code that is executed can be stored by the storage service 1100A or in another network accessible location.

In this regard, it is to be appreciated that the term “serverless compute service” as used herein is not intended to infer that servers are not utilized to execute the program code, but rather that the serverless compute service 1100C enables code to be executed without requiring a user to provision or manage server computers. The serverless compute service 1100C executes program code only when needed, and only utilizes the resources necessary to execute the code. In some configurations, the user or entity requesting execution of the code might be charged only for the amount of time required for each execution of their program code.

The service provider network 1100 can also include a cryptography service 1100D. The cryptography service 1100D can utilize storage services of the service provider network 1100, such as the storage service 1100A, to store encryption keys in encrypted form, whereby the keys can be usable to decrypt user keys accessible only to particular devices of the cryptography service 1100D. The cryptography service 1100D can also provide other types of functionality not specifically mentioned herein. The cryptography service 1100D may be used to support the use of credentials as discussed with reference to at least FIG. 6.

The service provider network 1100, in various configurations, also includes an authentication service 1100E and a policy management service 1100F. The authentication service 1100E, in one example, is a computer system (i.e., collection of computing resources) configured to perform operations involved in authentication of users or customers. For instance, one of the services shown in FIG. 11 can provide information from a user or customer to the authentication service 1100E to receive information in return that indicates whether or not the requests submitted by the user or the customer are authentic.

The policy management service 1100F, in one example, is a network service configured to manage policies on behalf of users or customers of the service provider network 1100. The policy management service 1100F can include an interface (e.g. API or a general user interface (GUI)) that enables customers to submit requests related to the management of a policy, such as a security policy. Such requests can, for instance, be requests to add, delete, change, or otherwise modify policy for a customer, service, or system, or for other administrative actions, such as providing an inventory of existing policies and the like.

The service provider network 1100 can additionally maintain other network services based, at least in part, on the needs of its customers. For instance, the service provider network 1100 can maintain a deployment service 1100G for deploying program code in some configurations. The deployment service 1100G provides functionality for deploying program code, such as to virtual or physical hosts provided by the on-demand computing service 1100B. Other services include, but are not limited to, database services, object-level archival data storage services, and services that manage, monitor, interact with, or support other services. The service provider network 1100 can also be configured with other network services not specifically mentioned herein in other configurations.

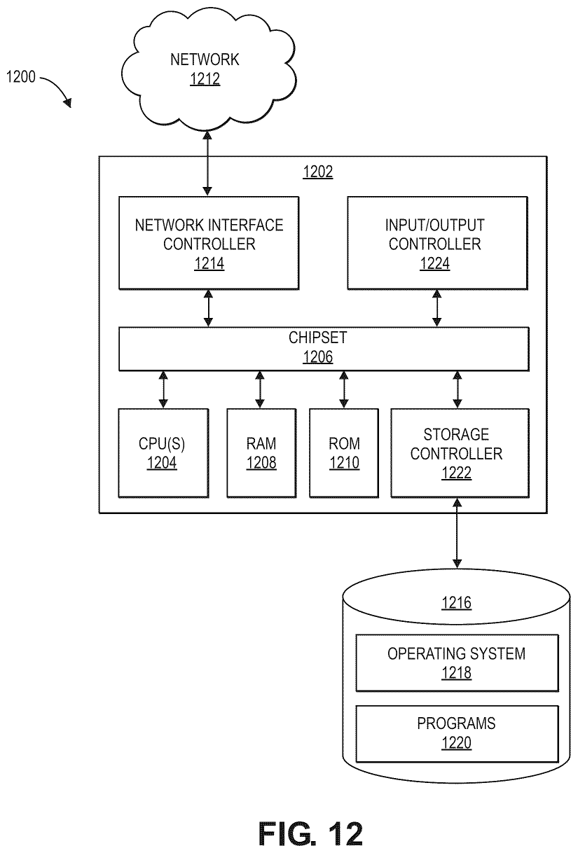

FIG. 12 shows an example computer architecture for a computer 1200 capable of executing program components for implementing the functionality described above. The computer architecture shown in FIG. 12 illustrates a conventional server computer, workstation, desktop computer, laptop, tablet, network appliance, e-reader, smartphone, or other computing device, and can be utilized to execute any of the software components presented herein. For example, the computer 1200 can execute one or more instances of the computing resources 102.

The computer 1200 includes a baseboard 1202, or “motherboard,” which may be one or more printed circuit boards to which a multitude of components and/or devices may be connected by way of a system bus and/or other electrical communication paths. In one illustrative configuration, one or more central processing units (“CPUs”) 1204 operate in conjunction with a chipset 1206. The CPUs 1204 can be standard programmable processors that perform arithmetic and logical operations necessary for the operation of the computer 1200.

The CPUs 1204 perform operations by transitioning from one discrete, physical state to the next through the manipulation of switching elements that differentiate between and change these states. Switching elements can generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 1206 provides an interface between the CPUs 1204 and the remainder of the components and devices on the baseboard 1202. The chipset 1206 can provide an interface to a RAM 1208, used as the main memory in the computer 1200. The chipset 1206 can further provide an interface to a computer-readable storage medium such as a read-only memory (“ROM”) 1210 or non-volatile RAM (“NVRAM”) for storing basic routines that help to startup the computer 1200 and to transfer information between the various components and devices. The ROM 1210 or NVRAM can also store other software components necessary for the operation of the computer 1200 in accordance with the configurations described herein.

The computer 1200 can operate in a networked environment using logical connections to remote computing devices and computer systems through a network, such as the network 1212. The chipset 1206 can include functionality for providing network connectivity through a NIC 1214, such as a gigabit Ethernet adapter. The NIC 1214 is capable of connecting the computer 1200 to other computing devices over the network 1212. It should be appreciated that multiple NICs 1214 can be present in the computer 1200, connecting the computer to other types of networks and remote computer systems.

The computer 1200 can be connected to a mass storage device 1216 that provides non-volatile storage for the computer. The mass storage device 1216 can store an operating system 1218, programs 1220, and data, which have been described in greater detail herein. The mass storage device 1216 can be connected to the computer 1200 through a storage controller 1222 connected to the chipset 1206. The mass storage device 1216 can consist of one or more physical storage units. The storage controller 1222 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 1200 can store data on the mass storage device 1216 by transforming the physical state of the physical storage units to reflect the information being stored. The specific transformation of physical state can depend on various factors, in different implementations of this description. Examples of such factors can include, but are not limited to, the technology used to implement the physical storage units, whether the mass storage device 1216 is characterized as primary or secondary storage, and the like.

For example, the computer 1200 can store information to the mass storage device 1216 by issuing instructions through the storage controller 1222 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 1200 can further read information from the mass storage device 1216 by detecting the physical states or characteristics of one or more particular locations within the physical storage units.

In addition to the mass storage device 1216 described above, the computer 1200 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 1200.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned above, the mass storage device 1216 can store an operating system 1218 utilized to control the operation of the computer 1200. According to one configuration, the operating system comprises the LINUX operating system or one of its variants such as, but not limited to, UBUNTU, DEBIAN, and CENTOS. According to another configuration, the operating system comprises the WINDOWS SERVER operating system from MICROSOFT Corporation. According to further configurations, the operating system can comprise the UNIX operating system or one of its variants. It should be appreciated that other operating systems can also be utilized. The mass storage device 1216 can store other system or application programs and data utilized by the computer 1200.

In one configuration, the mass storage device 1216 or other computer-readable storage media is encoded with computer-executable instructions which, when loaded into the computer 1200, transform the computer from a general-purpose computing system into a special-purpose computer capable of implementing the configurations described herein. These computer-executable instructions transform the computer 1200 by specifying how the CPUs 1204 transition between states, as described above. According to one configuration, the computer 1200 has access to computer-readable storage media storing computer-executable instructions which, when executed by the computer 1200, perform the various processes described above. The computer 1200 can also include computer-readable storage media for performing any of the other computer-implemented operations described herein.

The computer 1200 can also include one or more input/output controllers 1224 for receiving and processing input from a number of input devices, such as a keyboard, a mouse, a touchpad, a touch screen, an electronic stylus, or other type of input device. Similarly, an input/output controller 1224 can provide output to a display, such as a computer monitor, a flat-panel display, a digital projector, a printer, or other type of output device. It will be appreciated that the computer 1200 might not include all of the components shown in FIG. 12, can include other components that are not explicitly shown in FIG. 12, or can utilize an architecture completely different than that shown in FIG. 12.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers, communications, and machine learning should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some or all of the specific details and steps disclosed herein.

Moreover, with respect to the one or more methods or processes of the present disclosure shown or described herein, including but not limited to the flow charts shown in FIGS. 5-10, orders in which such methods or processes are presented are not intended to be construed as any limitation on the claimed inventions, and any number of the method or process steps or boxes described herein can be combined in any order, in parallel, and/or be omitted to implement the methods or processes described herein. Also, the drawings herein are not drawn to scale.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage media may be implemented by a volatile computer memory, non-volatile computer memory, hard drive, solid-state memory, flash drive, removable disk, and/or other media.

Disjunctive language such as the phrase “at least one of X, Y, or Z,” or “at least one of X, Y and Z,” unless specifically stated otherwise, is otherwise understood with the context as used in general to present that an item, term, etc., may be any of X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Unless otherwise explicitly stated, articles such as “a” or “an” should generally be interpreted to include one or more described items. Accordingly, phrases such as “a device configured to” or “a device operable to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly,” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Conditional language, such as, among others, “can,” “could,” “might,” or “may,” unless specifically stated otherwise, or otherwise understood within the context as used, is generally intended to convey in a permissive manner that certain implementations could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

Although the invention has been described and illustrated with respect to illustrative implementations thereof, the foregoing and various other additions and omissions may be made therein and thereto without departing from the spirit and scope of the present disclosure.

What is claimed is:

1. A system, comprising:
one or more processors; and
memory storing program instructions that, when executed by the one or more processors, cause the one or more processors to at least:
determine that a data source includes sensitive data;
shard the data source into at least a first shard and a second shard;
receive a request for generative text to be provided in part by a large language model (LLM) implemented with retrieval-augmented generation (RAG) and having access to at least the first shard and the second shard;
send a first query to the LLM implementing the RAG with the first shard to obtain first probabilities associated with first tokens used to determine a next token in the generative text;
send a second query to the LLM implementing the RAG with the second shard to obtain second probabilities associated with second tokens used to determine the next token in the generative text;
determine combined probabilities based in part on at least one of the first probabilities and second probabilities obtained from the LLM for tokens included in the first tokens and the second tokens;
select the next token for the generative text from the tokens based at least in part on the combined probabilities; and
generate, in response to the request, the generative text that includes a word associated with the next token.

2. The system of claim 1, wherein the program instructions that, when executed by the one or more processors, further cause the one or more processors to at least:
determine that additional data includes non-sensitive data; and
allocate the additional data to both the first shard and the second shard.

3. The system of claim 1, wherein:
determination of the combined probabilities includes calculating a weighted average for a first combined probability based on a first probability of the first probabilities and a second probability of the second probabilities for a first token.

4. The system of claim 1, wherein:
determination of the combined probabilities includes performing a smoothing function to determine a first combined probability of the combined probabilities for a first token as a value between at least one of:
a first probability of the first probabilities and a second probability of the second probabilities for the first token;
the first probability and zero; or
the second probability and zero.

5. The system of claim 1, wherein the program instructions that, when executed by the one or more processors, further cause the one or more processors to at least:
send a third query to the LLM implementing the RAG with the data source to obtain third probabilities associated with third tokens used to determine the next token in the generative text; and
wherein determination of the combined probabilities implements an upper limit for the combined probabilities as less than corresponding probabilities of the third probabilities.

6. A computer-implemented method, comprising:
determining a data source that includes data for use by one or more large language models (LLMs) implemented with retrieval-augmented generation (RAG);
sharding the data source into at least a first shard and a second shard;
receiving a request for a response to be provided by the one or more LLMs implemented with the RAG;
sending a first query to the one or more LLMs implemented with the RAG with the first shard to determine a first probability associated with a token used to determine at least part of the response;
sending a second query to at least one of the one or more LLMs implemented with the RAG with the second shard to determine a second probability associated with the token;
determining a combined probability associated with the token that is between the first probability and the second probability;
selecting the token based on the combined probability; and
generating, in response to the request, the response based at least in part on the token.

7. The computer-implemented method of claim 6, further comprising:
determining that the data source includes sensitive data that includes at least one of:
confidential data;
financial data;
personal data; or
legally protected data.

8. The computer-implemented method of claim 6, wherein:
the determining the combined probability includes generating a randomized weighted value to create a weighted average as the combined probability that is between the first probability and second probability.

9. The computer-implemented method of claim 6, wherein:
the determining the combined probability associated with the token includes performing a smoothing function that reduces the combined probability to a value less than an average of the first probability and the second probability.

10. The computer-implemented method of claim 6, further comprising:
sending a third query to at least one of the one or more LLMs implemented with the RAG with the data source to determine a third probability associated with the token; and
wherein the determining the combined probability further includes setting an upper limit for the combined probability to be less than the third probability.

11. The computer-implemented method of claim 6, wherein the data source includes a file;
the sharding the data source into the first shard includes allocating a first portion of data in the file to the first shard and omitting the first portion from the second shard; and
the sharding the data source into the second shard includes allocating a second portion of the data in the file to the second shard and omitting the second portion from the first shard.

12. The computer-implemented method of claim 6, wherein the data source includes at least two files;
the sharding the data source into the first shard includes allocating a first file of the at least two files to the first shard and omitting the first file from the second shard; and
the sharding the data source into the second shard includes allocating a second file of the at least two files to the second shard and omitting the second file from the first shard.

13. The computer-implemented method of claim 6, wherein:
determining that the token was selected from a shard that is the same as a threshold number of prior consecutive tokens; and
selecting the next token from a different shard than the shard associated with the threshold number of prior consecutive tokens.

14. The computer-implemented method of claim 6, wherein:
the first query is sent to a first LLM of the one or more LLMs; and
the second query is sent to a second LLM of the one or more LLMs that is different than the first LLM.

15. A system, comprising:
one or more processors; and
memory storing program instructions that, when executed by the one or more processors, cause the one or more processors to at least:
determine a data source that includes data for use by one or more large language models (LLMs) implemented with retrieval-augmented generation (RAG);
shard the data source into at least a first shard and a second shard;
receive a request to be fulfilled at least in part by the one or more LLMs implemented with the RAG;
send a first query to the one or more LLMs implemented with the RAG with the first shard to determine a first probability associated with a token used to determine a response;
send a second query to at least one of the one or more LLMs implemented with the RAG with the second shard to determine a second probability associated with the token;
determine a combined probability associated with the token based at least in part on the first probability and the second probability and less than the greater of the first probability and the second probability; and
select the token based on the combined probability.

16. The system of claim 15, wherein:
determination of the combined probability includes a weighted average that is between the first probability and second probability.

17. The system of claim 15, wherein the data source includes a file; and
the first shard includes allocation of a first portion of data in the file that is omitted from inclusion in the second shard; and
the second shard includes allocation of a second portion of data in the file that is omitted from inclusion in the first shard.

18. The system of claim 15, wherein the data source includes at least two files;
the first shard includes allocation of a first file of the at least two files that is omitted from inclusion in the second shard; and
the second shard includes allocation of a second file of the at least two files that is omitted from inclusion in the first shard.

19. The system of claim 15, wherein the program instructions that, when executed by the one or more processors, further cause the one or more processors to at least:
send a third query to at least one of the one or more LLMs implemented with the RAG with the data source to determine a third probability associated with the token; and
wherein the determination of the combined probability further includes setting an upper limit for the combined probability to be less than the third probability.

20. The system of claim 15, wherein the program instructions that, when executed by the one or more processors, further cause the one or more processors to at least:
create, in response to the request, generative text that includes a word associated with the token.
